(19) United States
(12) Patent Application Publication
(10) Pub. No.: US 2010/0172443 A1
(43) Pub. Date: Jul. 8, 2010

(54) SYSTEMS AND METHODS OF CLASSIFYING AND DECODING WIRELESS SIGNALS

(75) Inventors: Byonghyo Shim, San Diego, CA (US); Insung Kang, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/683,406

(22) Filed: Jan. 6, 2010

Related U.S. Application Data
(60) Provisional application No. 61/143,073, filed on Jan. 7, 2009.

(51) Int. Cl. H04L 27/06

(52) U.S. Cl. 375/320; 375/340

(57) ABSTRACT

Systems and methods of classifying and decoding wireless signals are disclosed. A receiver may receive wireless signals from multiple transmitters. The receiver may use sphere decoding to classify the wireless signals (e.g., determine the modulation scheme of the wireless signals) and decode the wireless signals (e.g., determine the symbol and/or symbols transmitted using the wireless signals).

### CLAIM OF PRIORITY UNDER 35 U.S.C. §119

The present Application for patent claims priority to U.S. Provisional Patent Application No. 61/143,073 entitled “JOINT DETECTION AND MODULATION CLASSIFICATION USING SPHERE DECODING” filed Jan. 7, 2009, and assigned to the assignee hereof and hereby expressly incorporated by reference herein.

### BACKGROUND

1. Field

The present application relates generally to wireless communication, and more specifically to systems and methods of classifying and decoding wireless signals.

2. Background

Wireless communication systems are widely deployed to provide various types of communication (e.g., voice, data, multimedia services, etc.) to multiple users. As the demand for high-rate and multimedia data services rapidly grows, there lies a challenge to implement efficient and robust communication systems with enhanced performance.

As wireless communication systems continue to grow, more and more wireless communication devices (e.g., access terminals, mobile phones, base stations, cells such as macro cells, femto cells and pico cells) may communicate using wireless signals over the same frequencies. For example, two mobile phones may communicate with their respective base stations using the same frequency. Due overlapping coverage areas, the base stations and/or mobile phones may be able to receive the wireless signals of other base stations and/or mobile phones on the same frequency. For example, mobile phone A may be communicating with base station B, but may also receive wireless signals transmitted by base station C. These other wireless signals transmitted by base station C may cause interference and may increase the amount of noise detected by mobile phone A. Thus, classifying and decoding the wireless signals transmitted by interfering wireless communication devices is desirable.

### SUMMARY

In one embodiment, a wireless communication apparatus operable in a communication system is provided. The wireless communication apparatus comprises a receiver configured to receive a first signal comprising at least M measurements, each measurement comprising at least a first symbol value selected from a first constellation weighted by a first gain and a second symbol value selected from a second constellation weighted by a second gain, the receiver further configured to receive a second signal comprising at least M measurements, each measurement comprising at least the first symbol value weighted by a third gain and the second symbol value weighted by a fourth gain; and a circuit configured to: generate an N-dimensional vector based on the first signal and the second signal, wherein N is at least 2M; obtain two or more N-dimensional lattices of lattice points, each lattice corresponding to a different candidate second constellation and each lattice point corresponding to a different possible vector value based at least in part on a first M possible symbol values selected from the first constellation and a second M possible symbol values selected from the candidate second constellation; identify, for each lattice, one or more lattice points, based on the N-dimensional vector, using sphere decoding; select, for each lattice, a particular one of the identified one or more lattice points based on a first metric; select a target lattice point from the selected lattice points based on a second metric including a bias based at least in part on M, the first constellation, the candidate second constellation of the selected lattice point, and a noise variance; determine the second constellation based on the target lattice point; and determine at least the M first symbol values and the M second symbol values based on the target lattice point.

In another embodiment, a method of determining a constellation is provide. The method comprises receiving a first signal comprising at least M measurements, each measurement comprising at least a first symbol value selected from a first constellation weighted by a first gain and a second symbol value selected from a second constellation weighted by a second gain; receiving a second signal comprising at least M measurements, each symbol comprising at least the first symbol value weighted by a third gain and the second symbol value weighted by a fourth gain; generating an N-dimensional vector based on the first signal and the second signal, wherein N is at least 2M; obtaining two or more N-dimensional lattices of lattice points, each lattice corresponding to a different candidate second constellation and each lattice point corresponding to a different possible vector value based at least in part on a first M possible symbol values selected from the first constellation and a second M possible symbol values selected from the candidate second constellation; identifying, for each lattice, one or more lattice points, based on the N-dimensional vector, using sphere decoding; selecting, for each lattice, a particular one of the identified one or more lattice points based on a first metric; selecting a target lattice point from the selected lattice points based on a second metric including a bias based at least in part on M, the first constellation, the candidate second constellation of the selected lattice point, and a noise variance; determining the second constellation based on the target lattice point; and determining at least the M first symbol values and the M second symbol values based on the target lattice point.

In yet another embodiment, a wireless communication apparatus is provided. The apparatus comprises means for receiving a first signal comprising at least M measurements, each measurement comprising at least a first symbol value selected from a first constellation weighted by a first gain and a second symbol value selected from a second constellation weighted by a second gain; means for receiving a second signal comprising at least M measurements, each measurement comprising at least the first symbol value weighted by a third gain and the second symbol value weighted by a fourth gain; means for generating an N-dimensional vector based on the first signal and the second signal, wherein N is at least 2M; means for obtaining two or more N-dimensional lattices of lattice points, each lattice corresponding to a different candidate second constellation and each lattice point corresponding to a different possible vector value based at least in part on a first M possible symbol values selected from the first constellation and a second M possible symbol values selected from the candidate second constellation; means for identifying, for each lattice, one or more lattice points, based on the N-dimensional vector, using sphere decoding; means for selecting, for each lattice, a particular one of the identified one or more lattice points based on a first metric; means for selecting a target lattice point from the selected lattice points based on a second metric including a bias based at least in part on M, the first constellation, the candidate second constellation of the selected lattice point, and a noise variance; means for determining the second constellation based on the target lattice point; and means for determining at least the M first symbol values and the M second symbol values based on the target lattice point.

In a further embodiment, a computer-readable storage medium having instructions encoded thereon which, when executed by one or more processors, causes an electronic device to perform a method of method of determining a constellation is provided. The method comprises receiving a first signal comprising at least M measurements, each measurement comprising at least first symbol value selected from a first constellation weighted by a first gain and a second symbol value selected from a second constellation weighted by a second gain; receiving a second signal comprising at least M measurements, each symbol comprising at least the first symbol value weighted by a third gain and the second symbol value weighted by a fourth gain; generating an N-dimensional vector based on the first signal and the second signal, wherein N is at least 2M; obtaining two or more N-dimensional lattices of lattice points, each lattice corresponding to a different candidate second constellation and each lattice point corresponding to a different possible vector value based at least in part on a first M possible symbol values selected from the first constellation and a second M possible symbol values selected from the candidate second constellation; identifying, for each lattice, one or more lattice points, based on the N-dimensional vector, using sphere decoding; selecting, for each lattice, a particular one of the identified one or more lattice points based on a first metric; selecting a target lattice point from the selected lattice points based on a second metric including a bias based at least in part on M, the first constellation, the candidate second constellation of the selected lattice point, and a noise variance; determining the second constellation based on the target lattice point; and determining at least the M first symbol values and the M second symbol values based on the target lattice point.

### BRIEF DESCRIPTION OF THE DRAWINGS

FIG. 1 illustrates an exemplary wireless communication network.

FIG. 2 illustrates exemplary interoperations of two or more communication networks.

FIG. 3 illustrates exemplary coverage areas of the wireless communication networks shown in FIG. 1.

FIG. 4 is a functional block diagram of a first exemplary femto node and a first exemplary access terminal in one of the communication networks of FIG. 2.

FIG. 5 illustrates a first exemplary constellation for the QPSK modulation scheme.

FIG. 6 illustrates a second exemplary constellation for the 8-PSK modulation scheme.

FIG. 7 illustrates a third exemplary constellation for the 16-QAM modulation scheme.

FIG. 8 shows a portion of a first exemplary plane of lattice points.

FIG. 9 shows a portion of a second exemplary plane of lattice points.

FIG. 10 is a flowchart illustrating an exemplary process which may be performed by the wireless communication devices shown in FIG. 2.

FIG. 11 is a functional block diagram of a wireless communication device which may be used in one of the communication networks of FIG. 2.

FIG. 12 is a flowchart illustrating a first exemplary process which may be performed by the wireless communication devices shown in FIG. 2.

FIG. 13 is a flowchart illustrating a second exemplary process which may be performed by the wireless communication devices shown in FIG. 2.

FIG. 14 is a functional block diagram of a second exemplary wireless communication device 1400 in one of the communication networks of FIG. 2.

FIG. 15 is a block diagram which illustrates a third exemplary process which may be performed by the wireless communication device shown in FIG. 2.

### DETAILED DESCRIPTION

The word “exemplary” is used herein to mean “serving as an example, instance, or illustration.” Any embodiment described herein as “exemplary” is not necessarily to be construed as preferred or advantageous over other embodiments. The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

In some aspects the teachings herein may be employed in a network that includes macro scale coverage (e.g., a large area cellular network such as a 3rd Generation (3G) networks, typically referred to as a macro cell network) and smaller scale coverage (e.g., a residence-based or building-based network environment). As an access terminal (“AT”) moves through such a network, the AT may be served in certain locations by access nodes (“ANs”) that provide macro coverage while the AT may be served at other locations by access nodes that provide smaller scale coverage. In some aspects, the smaller coverage nodes may be used to provide incremental capacity growth, in-building coverage, and different services (e.g., for a more robust user experience). In the discussion herein, a node that provides coverage over a relatively large area may be referred to as a macro node. A node that provides coverage over a relatively small area (e.g., a residence) may be referred to as a femto node. A node that provides coverage over an area that is smaller than a macro area and larger than a femto area may be referred to as a pico node (e.g., providing coverage within a commercial building).

A cell associated with a macro node, a femto node, or a pico node may be referred to as a macro cell, a femto cell, or a pico cell, respectively. In some implementations, each cell may be further associated with (e.g., divided into) one or more sectors.

In various applications, other terminology may be used to reference a macro node, a femto node, or a pico node. For example, a macro node may be configured or referred to as an access node, base station, access point, eNodeB, macro cell, and so on. Also, a femto node may be configured or referred to as a Home NodeB, Home eNodeB, access point base station, femto cell, and so on.

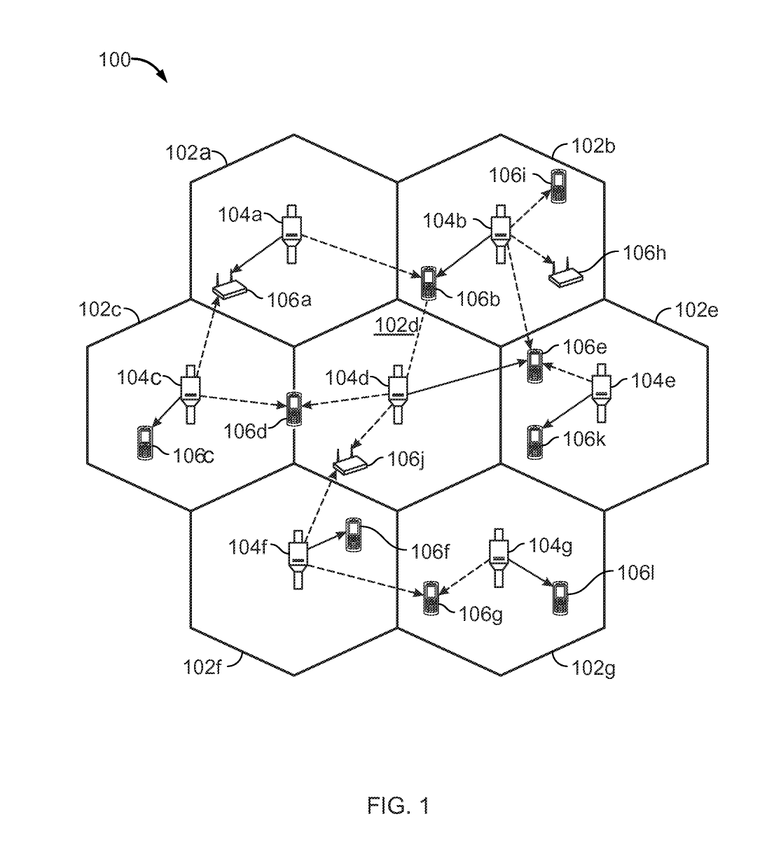

FIG. 1 illustrates an exemplary wireless communication network 100. The wireless communication network 100 is configured to support communication between a number of users. The wireless communication network 100 may be divided into one or more cells 102a through 102g. Communication coverage in cells 102a through 102g may be provided by one or more nodes 104a through 104g. Each of the nodes 104a through 104g may provide communication coverage to corresponding cells 102a through 102g. The nodes 104a through 104g may interact with a plurality of access terminals (ATs) 106a through 106l.

Each of the ATs 106a through 106l may communicate with one or more nodes 104a through 104g on a forward link (FL) and/or a reverse link (RL) at a given moment. A FL is a communication link from a node to an AT. A RL is a communication link from an AT to a node. The nodes 104a through 104g may be interconnected, for example, by appropriate wired or wireless interfaces and may be able to communicate with each other. Accordingly, each of the ATs 106a through 106l may communicate with another one of the ATs 106a through 106l through one or more nodes 104a through 104g. For example, the AT 106j may communicate with the AT 106h as follows. The AT 106j may communicate with the node 104d. The node 104d may then communicate with the node 104b. The node 104b may then communicate with the AT 106h. Accordingly, a communication is established between the AT 106j and the AT 106h.

The wireless communication network 100 may provide service over a large geographic region. For example, the cells 102a through 102g may cover only a few blocks within a neighborhood or several square miles in a rural environment. In one embodiment, each cell may be further divided into one or more sectors (not shown).

As described above, a node (e.g., 104a) may provide an access terminal (AT) (e.g., AT 106a) access within its coverage area to a communications network, such as, for example the internet or a cellular network.

An AT (e.g., 106a) may be a wireless communication device (e.g., a mobile phone, router, personal computer, server, etc.) used by a user to send and receive voice or data over a communications network. An access terminal (AT) may also be referred to herein as a user equipment (UE), as a mobile station (MS), or as a terminal device. As shown, ATs 106a, 106h, and 106j comprise routers. ATs 106b through 106g, 106i, 106k, and 106l comprise mobile phones. However, each of ATs 106a through 106l may comprise any suitable communication device.

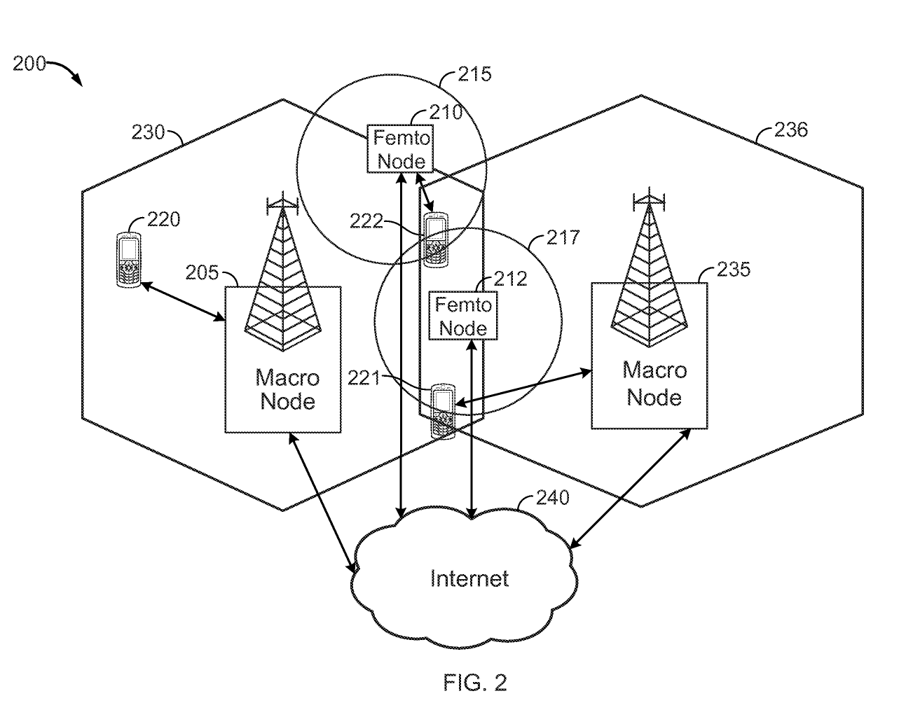

FIG. 2 illustrates exemplary interoperations of two or more communication networks. It may desirable for an AT 220 to transmit information to and receive information from another AT such as AT 221. FIG. 2 illustrates a manner in which the ATs 220, 221, and 222 may communicate with each other. As shown in FIG. 2, the macro node 205 may provide communication coverage to access terminals within a macro area 230. For example, the AT 220 may generate and transmit a message to the macro node 205. The message may comprise information related to various types of communication (e.g., voice, data, multimedia services, etc.). The AT 220 may communicate with the macro node 205 via a wireless link. The macro node 205 may communicate with a internet 240 (e.g., a network) via a wired link or via a wireless link. The femto nodes 210 and 212 may also communicate with the internet 240 via a wired link or via a wireless link. The AT 222 may communicate with the femto node 210 via a wireless link and the AT 221 may communicate with the macro node 235 via a wireless link.

The macro nodes 205 and 235 may also communicate with devices such as servers (not shown in FIG. 2) and switching centers (not shown in FIG. 2) through the internet 240. For example, the macro node 205 may transmit the message received from the AT 220 to a switching center (not shown in FIG. 2), which may forward the message to another network. The internet 240 may also be used to facilitate communication between the ATs 220, 221, and 222. For example, the AT 220 may be in communication with the AT 221. The AT 220 may transmit a message to the macro node 205. The macro node may forward the message to the internet 240. The internet 240 may forward the messages to the macro node 235. The macro node 235 may forward the message to the AT 221. Similarly, the reverse path may be followed from the AT 221 to the AT 220. In another example, the AT 221 may be in communication with the AT 222. The AT 221 may transmit a message to the macro node 235. The macro node 235 may forward the message to the internet 240. The internet 240 may forward the message to the femto node 210. The femto node 210 may forward the message to the AT 222. Similarly, the reverse path may be followed from the AT 222 to the AT 221.

In one embodiment, the femto nodes 210, 212 may be deployed by individual consumers and placed in homes, apartment buildings, office buildings, and the like. The femto nodes 210, 212 may communicate with the ATs in a predetermined range (e.g., 100 m) of the femto nodes 210, 212 utilizing a predetermined cellular transmission band. In one embodiment, the femto nodes 210, 212 may communicate with the internet 240 by way of an Internet Protocol (IP) connection, such as a digital subscriber line (DSL, e.g., including asymmetric DSL (ADSL), high data rate DSL (HDSL), very high speed DSL (VDSL), etc.), a TV cable carrying Internet Protocol (IP) traffic, a broadband over power line (BPL) connection, or other link.

The internet 240 may comprise any type of electronically connected group of computers and/or devices including, for instance, the following networks: Internet, Intranet, Local Area Networks (LAN) or Wide Area Networks (WAN). In addition, the connectivity to the network may be, for example, remote modem, Ethernet (IEEE 802.3), Token Ring (IEEE 802.5), Fiber Distributed Datalink Interface (FDDI) Asynchronous Transfer Mode (ATM), Wireless Ethernet (IEEE 802.11), or Bluetooth (IEEE 802.15.1). Note that computing devices may be desktop, server, portable, hand-held, set-top, or any other desired type of configuration. As used herein, the internet 240 includes network variations such as the public Internet, a private network within the Internet, a secure network within the Internet, a private network, a public network, a value-added network, an intranet, and the like. In certain embodiments, internet 240 may also comprise a virtual private network (VPN).

As discussed above, the coverage area of two femto nodes may overlap as shown in FIG. 2. The femto node 210 has a first coverage area 215. The first coverage area 215 may comprise one or more geographical areas in which the AT 222 may access the internet 240. The first coverage area 215 may also comprise one or more geographical areas in which the AT 222 may communicate with the femto node 210. The femto node 212 has a second coverage area 217. The second coverage area 217 may comprise one or more geographical areas in which the AT 221 may access the internet 240. The second coverage area 217 may also comprise one or more geographical areas in which an AT (e.g. AT 221) may communicate with the femto node 212. The first coverage area 215 and the second coverage area 217 overlap. The AT 222 may be located within the overlapping regions of the first coverage area 215 and the second coverage area 217. In addition, the macro node 235 has a coverage area 236. The coverage areas 230 and 236 of the macro nodes 205 and 235, respectively, may overlap, as shown in FIG. 2. The coverage area 236 of the macro node 235 may also overlap with the coverage areas 215 and 217 of the femto nodes 210 and 212, respectively.

Due to the overlapping cover areas of the femto nodes 210 and 212 and the macro nodes 205 and 235, the various nodes and ATs shown in FIG. 2 may receive wireless signals from interfering wireless communication devices. For example, the AT 222 may be communicating with the femto node 210, but the AT 222 may also receive interfering wireless signals transmitted from the femto node 212. In another example, the AT 222 may be communicating with the femto node 210, but the AT 222 may also receive interfering wireless signals transmitted from the macro node 235. In yet another example, the AT 221 may be communicating with the macro node 235, but AT 221 may also receive interfering wireless communication signals from the femto node 212.

In one embodiment, the AT 221 may communicate with the macro node 235 via a wireless communication link on a certain frequency. The AT 221 may also receive wireless signals from the macro node 205 on the same frequency. The wireless signals received by the AT 221 may be described as follows:

y=Ts+v=T₀s₀+T₁s₁+v (1)

where y is the total received signal that AT 221 receives on the wireless communication link. Ts is the total signal received from wireless communication devices (e.g., the macro nodes 205 and 235). v is the noise that the AT 221 receives on the wireless communication link. Ts may be separated into two components, T₀s₀ and T₁s₁. T₀s₀ is the channel matrix and the symbol vectors (e.g., the symbols or transmitted information) for a known signal (e.g., for the wireless signals received from the macro node 235 by the AT 221). T₁s₁ is the channel matrix and the symbol vectors (e.g., the symbols or transmitted information) for an unknown signal (e.g., the wireless signals received from the macro node 205 by the AT 221). In one embodiment, T₁s₁ may comprise interference caused by communication devices operating on the same frequency (e.g., macro 205, femto node 212, or AT 222).

The AT 221 may classify the unknown signal T₁s₁ to be noise, since the AT 221 may not be able to decode the unknown signal T₁s₁. If the AT 221 classifies the unknown signal T₁s₁ as noise and/or interference, then the wireless signals received by the AT 221 may be described as follows:

y=T₀s₀+v′ (2)

where v′=T₁s₁+v. Thus, the signal-to-noise ratio (SNR) for the received signal may be described as:

$$SNR = \frac{E {\vert {T}_{0} {s}_{0} \vert}^{2}}{E {\vert {T}_{1} {s}_{1} \vert}^{2} + {σ}_{v}^{2}} \qquad ( 3 )$$

where σ_{ν}²=E|v|². In one embodiment, the AT 221 may be able to classify and/or decode the unknown signal T₁s₁. Thus the AT 221 may be able to determine the true amount of noise v that the received signal comprises since the AT 221 no longer classifies T₁s₁ as noise along with the true amount of noise v. This classification and/or decoding of an unknown signal may be referred to as multi-user detection (MUD). If the AT 221 is capable of MUD, then the SNR detected by the AT 221 may be described as:

$${SNR}_{mud} = \frac{E {\vert Ts \vert}^{2}}{{σ}_{v}^{2}} \qquad ( 4 )$$

In one embodiment, SNR_{mud} may be larger than SNR. If the AT 221 is capable of MUD, then the AT 221 may experience less noise and/or interference on the wireless communication link. This may allow the AT 221 to experience a performance gain on the wireless communication link between the AT 221 and the femto node 235. For example, the AT 221 may be able to transmit data at a faster data rate. In another example, the AT 221 may be able to maintain the wireless communication channel at a distance farther than the AT 221 would normally be able to if the AT 221 was not MUD capable.

The operator of the femto node 210 may subscribe to a mobile service, such as, for example, 3G mobile service, offered through the communication internet 240 (e.g., a mobile operator core network). In addition, the access terminal 222 may be capable of operating both in macro environments (e.g., macro areas) and in smaller scale (e.g., residential, femto areas, pico areas, etc.) network environments. In other words, depending on the current location of the access terminal 222, the access terminal 222 may access the communication internet 240 by the any one of a set of macro nodes (e.g., macro nodes 205, 235) or by any one of a set of femto nodes (e.g., femto nodes 210, 212). For example, when a subscriber is outside his home, he may be served by a macro node (e.g., node 205) and when the subscriber is at home, he may be served by a femto node (e.g., node 210). It should further be appreciated that the femto nodes 210 may be backward compatible with existing access terminals 222.

The macro nodes 205, 235 and the femto nodes 220 and 235 may communicate with ATs 220, 221, and 222 over a single frequency or, in the alternative, over multiple frequencies. Depending on the particular configuration, the single frequency or one or more of the multiple frequencies may overlap with one or more frequencies used by a macro node (e.g., node 205) and/or another femto node (e.g., femto node 212).

In one embodiment, the access terminal 222 may be configured to connect to a particular (e.g., preferred) femto node (e.g., a home femto node of the access terminal 222) and/or particularly macro node whenever the access terminal 222 is within communication range of the femto node and/or macro node. For example, the AT 222 may communicate with only the femto node 210 when the AT 222 is within the femto area 215. In another example, the AT 222 may communicate with macro node 205 whenever it is within the coverage area 230.

In another embodiment, the access terminal 221 is communicating with a node but is not communicating with a preferred node (e.g., as defined in a preferred roaming list). In this embodiment, the access terminal 221 may continue to search for a preferred node (e.g., the preferred femto node 210) using a Better System Reselection (“BSR”). The BSR may comprise a method comprising a periodic scanning of available systems to determine whether better systems are currently available. The BSR may further comprise attempting to associate with available preferred systems. The access terminal 222 may limit the BSR to scanning over one or more specific bands and/or channels. Upon discovery of a preferred femto node (e.g., femto node 210) and/or macro node (e.g., macro node 205), the access terminal 222 selects the femto node 210 and/or macro node 220 for communicating with to access the communication internet 240.

In one embodiment, a node may only provide certain services to certain access terminals. Such a node may be referred to as a “restricted” or “closed” node. In wireless communication networks comprising restricted femto nodes, a given access terminal may only be served by macro nodes and a defined set of femto nodes (e.g., the femto node 210). In other embodiments, a node may be restricted to not provide at least one of: signaling, data access, registration, paging, or service.

In one embodiment, a restricted femto node (which may also be referred to as a Closed Subscriber Group Home NodeB) is one that provides service to a restricted provisioned set of access terminals. This set may be temporarily or permanently changed to include additional or fewer access terminals as necessary. In some aspects, a Closed Subscriber Group (“CSG”) may be defined as the set of access nodes (e.g., femto nodes) that share a common access control list of access terminals (e.g., a list of the restricted provisioned set of access terminals). A channel on which all femto nodes (or all restricted femto nodes) in a region operate may be referred to as a femto channel.

Various relationships may thus exist between a given femto node and a given access terminal. For example, from the perspective of an access terminal, an open femto node may refer to a femto node with no restricted association. A restricted femto node may refer to a femto node that is restricted in some manner (e.g., restricted for association and/or registration). A home femto node may refer to a femto node on which the access terminal is authorized to access and operate on. A guest femto node may refer to a femto node on which an access terminal is temporarily authorized to access or operate on. An alien femto node may refer to a femto node on which the access terminal is not authorized to access or operate on, except for perhaps emergency situations (e.g., 911 calls).

From a restricted femto node perspective, a home access terminal may refer to an access terminal that is authorized to access the restricted femto node. A guest access terminal may refer to an access terminal with temporary access to the restricted femto node. An alien access terminal may refer to an access terminal that does not have permission to access the restricted femto node, except for perhaps emergency situations, such as 911 calls.

For convenience, the disclosure herein describes various functionalities related to a femto node. It should be appreciated, however, that a pico node may provide the same or similar functionality for a larger coverage area. For example, a pico node may be restricted, a home pico node may be defined for a given access terminal, and so on.

A wireless multiple-access communication system may simultaneously support communication for multiple wireless access terminals. As mentioned above, each access terminal may communicate with one or more nodes via transmissions on the forward and reverse links. The forward link (or downlink) refers to the communication link from the node to the access terminal, and the reverse link (or uplink) refers to the communication link from the access terminal to the node. This communication link may be established via a single-in-single-out system, a multiple-in-multiple-out (“MIMO”) system, or some other type of system.

A MIMO system employs multiple (NT) transmit antennas and multiple (NR) receive antennas for data transmission. A MIMO channel formed by the NT transmit and NR receive antennas may be comprise NS independent channels, which are also referred to as spatial channels, where NS≦min{NT, NR}. Each of the NS independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (“TDD”) and frequency division duplex (“FDD”). In a TDD system, the forward and reverse link transmissions are on the same frequency region so that the reciprocity principle allows the estimation of the forward link channel from the reverse link channel. This enables a device (e.g., a node, an access terminal, etc.) to extract a transmit beam-forming gain on the forward link when multiple antennas are available at the device.

The teachings herein may be incorporated into a device (e.g., a node, an access terminal, etc.) employing various components for communicating with at least one other device.

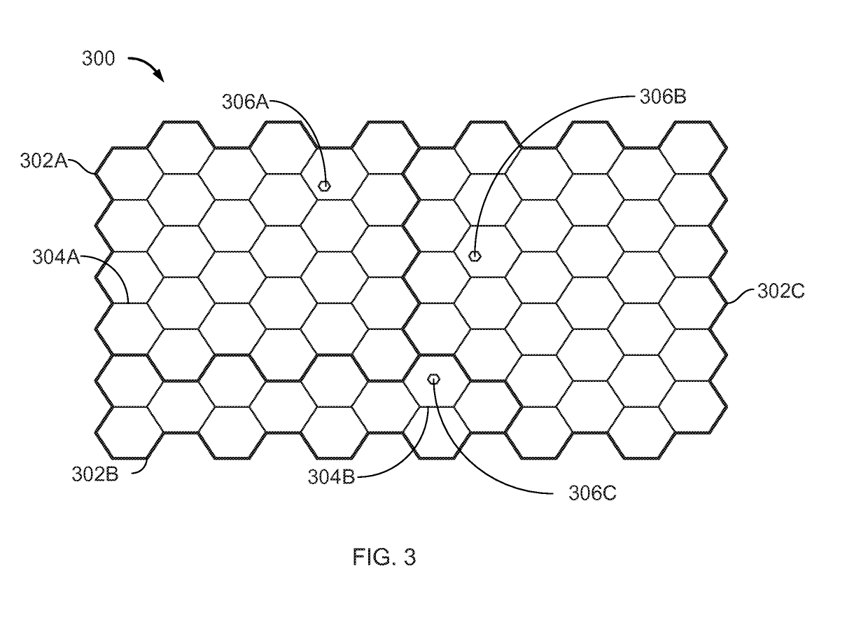

FIG. 3 illustrates exemplary coverage areas of the wireless communication networks 100 shown in FIG. 1. The coverage area 300 may comprise one or more geographical areas in which an AT (e.g., the AT 220 shown in FIG. 2) may access a network (e.g., the internet 240 shown in FIG. 2). As shown the coverage area 300 comprises several tracking areas 302A through 302C (or routing areas or location areas). Each of the tracking areas 302A through 302C comprises several macro areas such as 304A and 304B, which may be similar to the macro area 230 described above with respect to FIG. 2. Here, areas of coverage associated with tracking areas 302A, 302B, and 302C are shown as delineated by bolded lines, and the macro areas such as 304A and 304B are represented by hexagons. The tracking areas 302A through 302C may also comprise femto areas such as femto areas 306A through 306C, which may be similar to the femto area 230 described above with respect to FIG. 2. In this example, each of the femto areas (e.g., femto area 306C) is depicted within a macro area (e.g., macro area 304B). It should be appreciated, however, that a femto area (e.g., femto area 306C) may not lie entirely within a macro area (e.g., macro area 304B). In practice, a large number of femto areas (e.g., femto area 306C) may be defined with a given tracking area (e.g., tracking area 302B) or macro area (e.g., macro area 304B). Also, one or more pico areas (not shown) may be defined within a given tracking area (e.g., tracking area 302B) or macro area (e.g., macro area 304B).

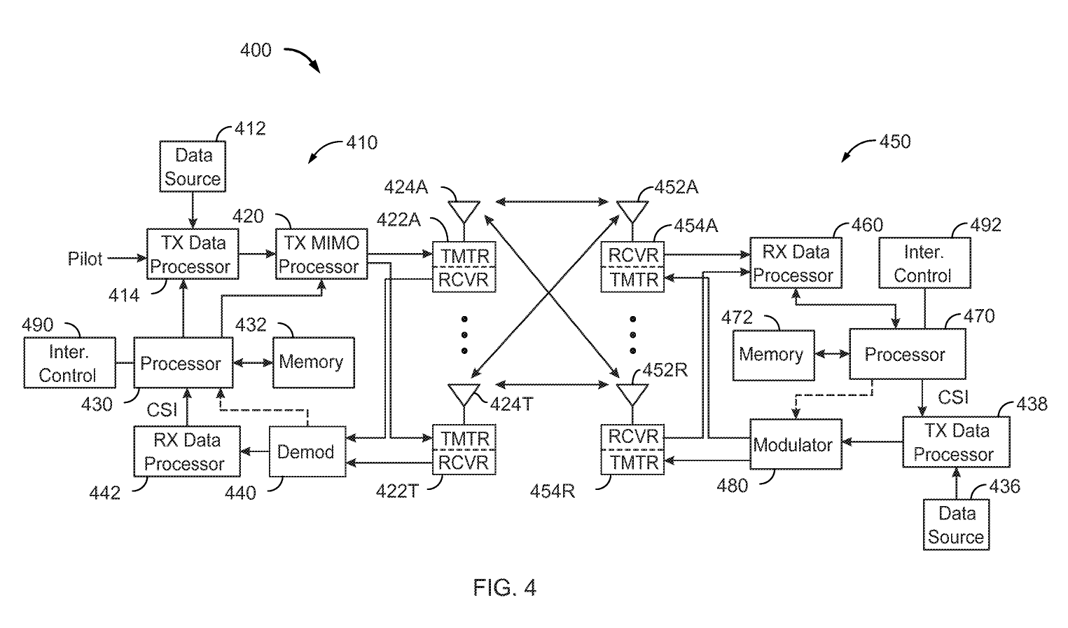

FIG. 4 is a functional block diagram of a first exemplary femto node 410 and a first exemplary access terminal 450 in one of the communication networks of FIG. 2. As shown, a MIMO system 400 comprises a femto node 410 and an access terminal 450 (e.g., the AT 222). At the femto node 410, traffic data for a number of data streams is provided from a data source 412 to a transmit (“TX”) data processor 414.

In one embodiment, each data stream is transmitted over a respective transmit antenna. The TX data processor 414 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 430. A data memory 432 may store program code, data, and other information used by the processor 430 or other components of the femto node 410.

The modulation symbols for all data streams are then provided to a TX MIMO processor 420, which may further process the modulation symbols (e.g., for OFDM). The TX MIMO processor 420 then provides NT modulation symbol streams to NT transceivers (“XCVR”) 422A through 422T. In some aspects, the TX MIMO processor 420 applies beam-forming weights to the symbols of the data streams and to the antenna from which the symbol is being transmitted.

Each of transceivers 422A through 422T receives and processes a respective symbol stream to provide one or more analog signals, and further conditions (e.g., amplifies, filters, and upconverts) the analog signals to provide a modulated signal suitable for transmission over the MIMO channel. NT modulated signals from transceivers 422A through 422T are then transmitted from NT antennas 424A through 424T, respectively.

At the femto node 450, the transmitted modulated signals are received by NR antennas 452A through 452R and the received signal from each of antennas 452A through 452R is provided to a respective transceiver (“XCVR”) 454A through 454R. Each of transceivers 454A through 454R conditions (e.g., filters, amplifies, and downconverts) a respective received signal, digitizes the conditioned signal to provide samples, and further processes the samples to provide a corresponding “received” symbol stream.

A receive (“RX”) data processor 460 then receives and processes the NR received symbol streams from NR transceivers 454A through 454R based on a particular receiver processing technique to provide NT “detected” symbol streams. The RX data processor 460 then demodulates, deinterleaves, and decodes each detected symbol stream to recover the traffic data for the data stream. The processing performed by the RX data processor 460 is complementary to that performed by the TX MIMO processor 420 and the TX data processor 414 at the femto node 410.

A processor 470 periodically determines which pre-coding matrix to use (discussed below). The processor 470 formulates a reverse link message comprising a matrix index portion and a rank value portion. A data memory 472 may store program code, data, and other information used by the processor 470 or other components of the femto node 450.

The reverse link message may comprise various types of information regarding the communication link and/or the received data stream. The reverse link message is then processed by a TX data processor 438. The TX data processor 438 also receives traffic data for a number of data streams from a data source 436. The modulator 480 modulates the data streams. Further, the transceivers 454A through 454R condition the data streams and transmits the data streams back to the femto node 410.

At the femto node 410, the modulated signals from the femto node 450 are received by the antennas 424A through 424T. Further, the transceivers 422A through 422T condition the modulated signals. A demodulator (“DEMOD”) 440 demodulates the modulated signals. A RX data processor 442 processes the demodulated signals and extracts the reverse link message transmitted by the femto node 450. The processor 430 then determines which pre-coding matrix to use for determining the beam-forming weights. Further, the processor 430 processes the extracted message.

Further, the femto node 410 and/or the femto node 450 may comprise one or more components that perform interference control operations as taught herein. For example, an interference (“INTER”) control component 490 may cooperate with the processor 430 and/or other components of the femto node 410 to send/receive signals to/from another device (e.g., femto node 450) as taught herein. Similarly, an interference control component 492 may cooperate with the processor 470 and/or other components of the femto node 450 to send/receive signals to/from another device (e.g., femto node 410). It should be appreciated that for each femto node 410 and 450 the functionality of two or more of the described components may be provided by a single component. For example, a single processing component may provide the functionality of the interference control component 490 and the processor 430. Further, a single processing component may provide the functionality of the interference control component 492 and the processor 470.

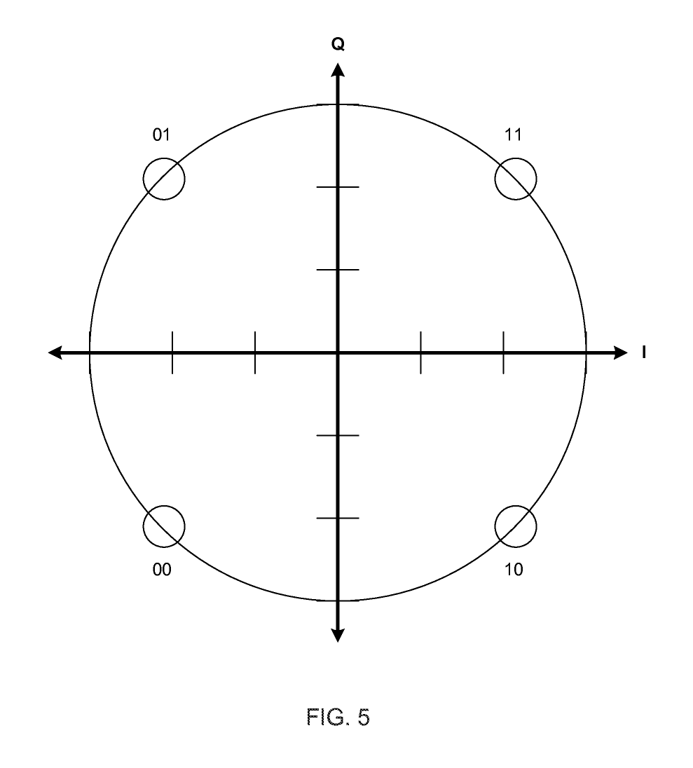

FIGS. 5 through 7 show exemplary constellations for different modulation schemes which may be used in the communication network shown in FIG. 2. As discussed above in FIG. 2, the AT 221 may be in communication with the macro node 235 via a wireless communication link. The AT 221 and the macro node 235 may transmit data between each other using the wireless communication link. In one embodiment, the data transmitted between the AT 221 and the macro node 235 may be modulated by the AT 221 and/or the macro node 235 so that it may be transmitted over the wireless communication link (e.g., transmitted using a particular frequency). In one embodiment, the AT 221 and the macro node 235 may use any one of a variety of modulation schemes including, but not limited to, QPSK, 4-PSK, 8-PSK, 16-PSK, 4-QAM, 8-QAM, 16-QAM, and 64-QAM. In one embodiment, a modulation scheme may use different symbols (e.g., a bit pattern) in order to transmit data. The symbols may be transmitted over the wireless communication link between the AT 221 and the macro node 235 using the modulation scheme associated with the symbols. The set of symbols associated with a modulation scheme may be referred to as a modulation alphabet.

In one embodiment, the symbols in the modulation alphabet may be converted into and/or represented as complex numbers. Generally, a complex number may be a number that comprises a real number and an imaginary number. A complex number may be mapped on a complex plane. Generally, a complex plane may be a plane similar to a normal x-y plane (e.g., a 2-dimensional plane with an X-axis and a Y-axis). Generally, the vertical axis of a complex plane may be referred to as the quadrature or Q-axis. Generally, the horizontal axis of a complex plane may be referred to as the in phase or I-axis. The values of the Q-axis may represent the imaginary number part of a complex number and the values of the I-axis may represent the real number part of a complex number. When a symbol is converted to a complex number, it may be plotted on the complex plane using the real number and imaginary number parts. Thus, all the symbols (e.g., the modulation alphabet) for a modulation scheme may be plotted on a complex plane. This plotting of the modulation alphabet for a modulation scheme onto a complex plane creates a constellation. A constellation comprises all of the symbols in the modulation alphabet plotted onto the complex plane. Each of the symbols on the constellation comprises a constellation point.

FIG. 5 illustrates a first exemplary constellation for the QPSK modulation scheme. The modulation alphabet for the QPSK modulation scheme comprises four symbols: 00, 01, 10, and 11. Each of the four symbols is converted into a complex number and mapped onto the complex plane, with 00 in the bottom left quadrant, 01 in the top left quadrant, 10 in the bottom right quadrant, and 11 in the top right quadrant of the complex plane.

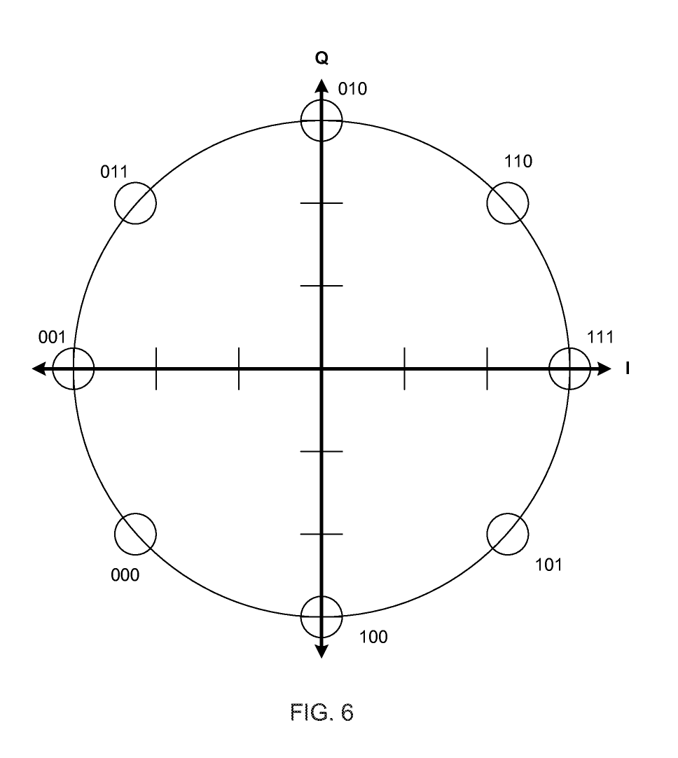

FIG. 6 illustrates a second exemplary constellation for the 8-PSK modulation scheme. The modulation alphabet for the 8-PSK modulation scheme comprises eight symbols: 000, 001, 010, 011, 100, 101, 110, and 111. Each of the eight symbols is converted into a complex number and mapped onto the complex plane, with 000 in the bottom left quadrant, 001 on the left side of the I-axis, 011 in the top left quadrant, 010 on the top of the Q-axis, 110 on the top right quadrant, 111 on the right side of the I-axis, 101 in the bottom right quadrant, and 100 on the bottom side of the Q-axis.

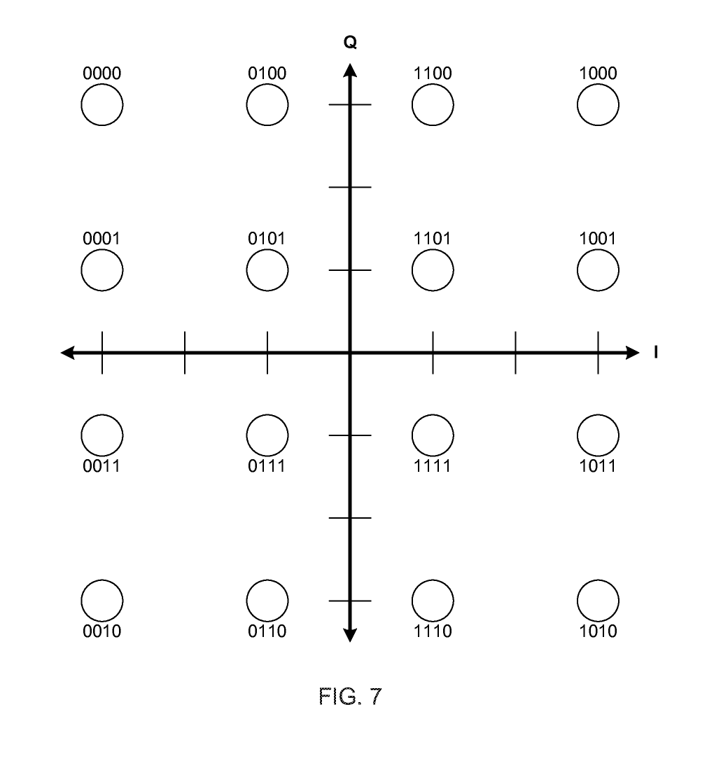

FIG. 7 illustrates a third exemplary constellation for the 16-QAM modulation scheme. The modulation alphabet for the 16-QAM modulation scheme comprises sixteen symbols: 0000, 0001, 0010, 0011, 0100, 0101, 0110, 0111, 1000, 1001, 1010, 1011, 1100, 1101, 1110, and 1111. Each of the sixteen symbols is converted into a complex number and mapped onto the complex plane, with 0011, 0111, 0010, and 0110 in the lower left quadrant, 0000, 0100, 0001, and 0101 in the upper left quadrant, 1100, 1000, 1101, and 1101 in the upper right quadrant, and 1111, 1011, 1110, and 1010 in the lower right quadrant.

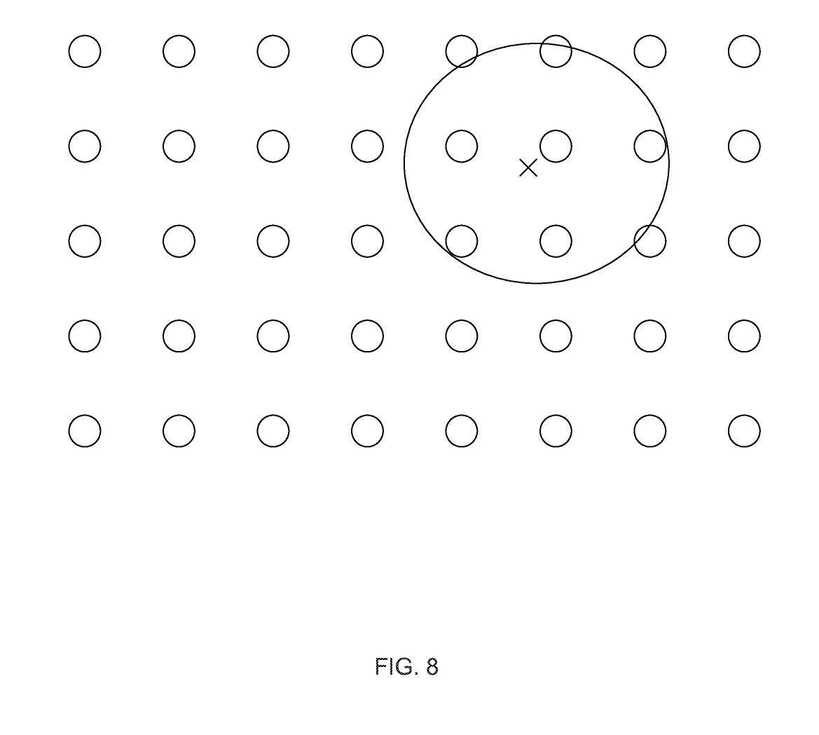

FIG. 8 shows a portion of a first exemplary plane of lattice points. In one embodiment, the macro node 235 may transmit a first wireless signal comprising 2 symbol, s1 and s2, and the macro node 205 may transmit a second wireless signal comprising 2 symbols, s3 and s4. The symbols s1, s2, s3, and s4, are placed into a received vector as follows: v1=[s1, s2, s3, s4]. As discuss earlier, the symbols s1 and s2 transmitted by the macro node 235 use a modulation scheme known to the AT 221 and the symbols s3 and s4 transmitted by the macro node 205 use a modulation scheme unknown to the AT 221. Also, as discussed earlier, the wireless communication system 200 uses one of two modulations schemes, QPSK or 16-QAM. Thus, in this embodiment, there are two possibilities: 1) the macro node 235 uses QPSK, and the macro node 205 uses QPSK; 2) the macro node 235 uses QPSK and the macro node 205 uses 16-QAM. In the first possibility, there are 256 possible combinations of values for the symbols in the received vector v1 (e.g. 256 possible vectors), since each symbol in the vector can comprise one of four possible values. If the macro node 235 uses QPSK, and the macro node 205 uses QPSK, a first plane of 256 lattice points may be obtained. Each of the possible values for the vector v1 is shown as a point in the first plane of lattice points. FIG. 8 shows a portion of the first plane of lattice points. The received vector v1 may then be mapped onto the first plane, and sphere decoding may be performed in order to select a subset of all of the lattice points in the first plane. The received vector is shown as an “x” in FIG. 8. When sphere decoding is used, all the points within a certain distance (e.g., a radius) of the received vector v1 are selected. Thus, a circle is shown around the received vector v1. As shown in FIG. 8, only five points lie completely within the circle drawn around the received vector v1. The AT 221 may then determine which of the five points selected using sphere decoding, is closest to the received vector v1.

Finding the closest lattice point to the received vector v1 in the first plane may be referred to as a maximum likelihood (ML) cost function and may be represented by the function J(sₖ(Λ₀).

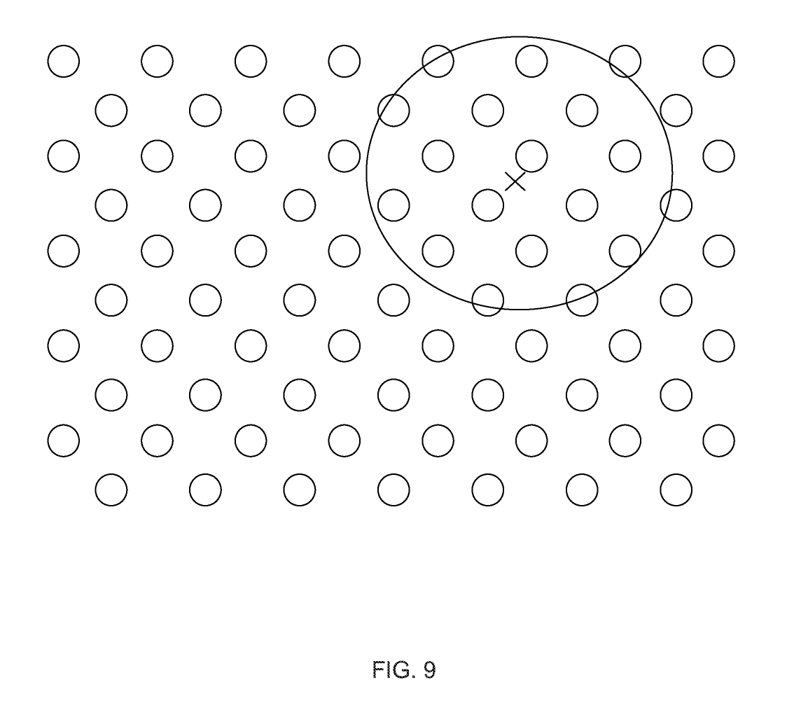

FIG. 9 shows a portion of a second exemplary plane of lattice points. As discussed above in FIG. 8, there are two possibilities. In the second possibility, the macro node 235 uses QPSK and the macro node 205 uses 16-QAM. In the second possibility, there are 4096 possible combinations of values for the symbols in the received vector v1 (e.g. 4096 possible vectors). This is because s1 and s2 each have four possible values and s3 and s4 each of 16 possible values. Thus the total number of possible values of the symbols s1 through s4 in the received vector v1 is 4×4×16×16. If the macro node 235 uses QPSK, and the macro node 205 uses QPSK, a first plane of 4096 lattice points may be obtained. Each of the possible values for the vector v1 is shown as a point in the first plane of lattice points. FIG. 9 shows a portion of the first plane of lattice points. The received vector v1 may then be mapped onto the first plane, and sphere decoding may be performed in order to select a subset of all of the lattice points in the first plane. The received vector is shown as an “x” in FIG. 9. When sphere decoding is used, all the points within a certain distance (e.g., a radius) of the received vector v1 are selected. Thus, a circle is shown around the received vector v1. As shown in FIG. 9, only eleven points lie completely within the circle drawn around the received vector v1. The AT 221 may then determine which of the eleven points selected using sphere decoding, is closest to the received vector v1.

Finding the closest lattice point to the received vector v1 in the first plane may be referred to as a maximum likelihood (ML) cost function and may be represented by the function J(sₖ(Λ₁).

After selecting a first closest point from the first plane shown in FIG. 8 and a second closest point from the second plan shown in FIG. 9, the AT 221 may then compare a first distance between the closest point from the first plane and the received vector shown in FIG. 8, and a second distance between the closest point from the second plane and the received vector v1, shown in FIG. 9. Additionally, the AT 221 may add a bias to at least one of the first distance and the second distance. After adding the bias, the AT 221 may select one of the first closest point and the second closest point. The AT 221 may then determine the values of the symbols s1, s2, s3, and s4, based on the selected point. In addition, the AT 221 may determine which modulation scheme is used by the macro node 205 based on the selected point.

In one embodiment, selecting between the first closest point and the second closest point may be represented via the following equation

$${\sum }_{k} J ( {\hat{s}}_{k} ( {Λ}_{0} ) ) \geq {\sum }_{k} ( J ( {\hat{s}}_{k} ( {Λ}_{1} ) ) + 2 {σ}^{2} {m}_{1} log \frac{\vert {X}_{1} \vert}{\vert {X}_{0} \vert} ) \qquad ( 5 )$$

As discussed above, a bias may of

$$2 {σ}^{2} {m}_{1} log \frac{\vert {X}_{1} \vert}{\vert {X}_{0} \vert}$$

may be added to the comparison in order to compensate for noise and/or interference which may be present in the combined wireless signal. σ² may comprise a noise variance (e.g., changes in noise over time). m₁ may comprise the number of symbols transmitted in the combined wireless signal.

$$\frac{\vert {X}_{1} \vert}{\vert {X}_{0} \vert}$$

may comprise the cardinality (e.g., the number of constellation points in the modulation scheme). This bias may be added to compensate for a tendency of the AT 221 to select the higher order modulation in a noisy communication system.

Although the above-embodiment uses the distance between points when selecting between the first and second point, other embodiments may use other types of metrics (e.g., values of cost functions and probabilities) may be used. In addition, although the above-embodiments discuss only four symbols, s1 through s4, more symbols may be used, for example, there may be symbols s1 through s10. Also, although the above-embodiments discuss only two possible modulation schemes, the communication system 200 may use more modulation schemes. The embodiments described herein may be applied to any number of symbols transmitted by different transmitters and any number of modulation schemes used by the different transmitters.

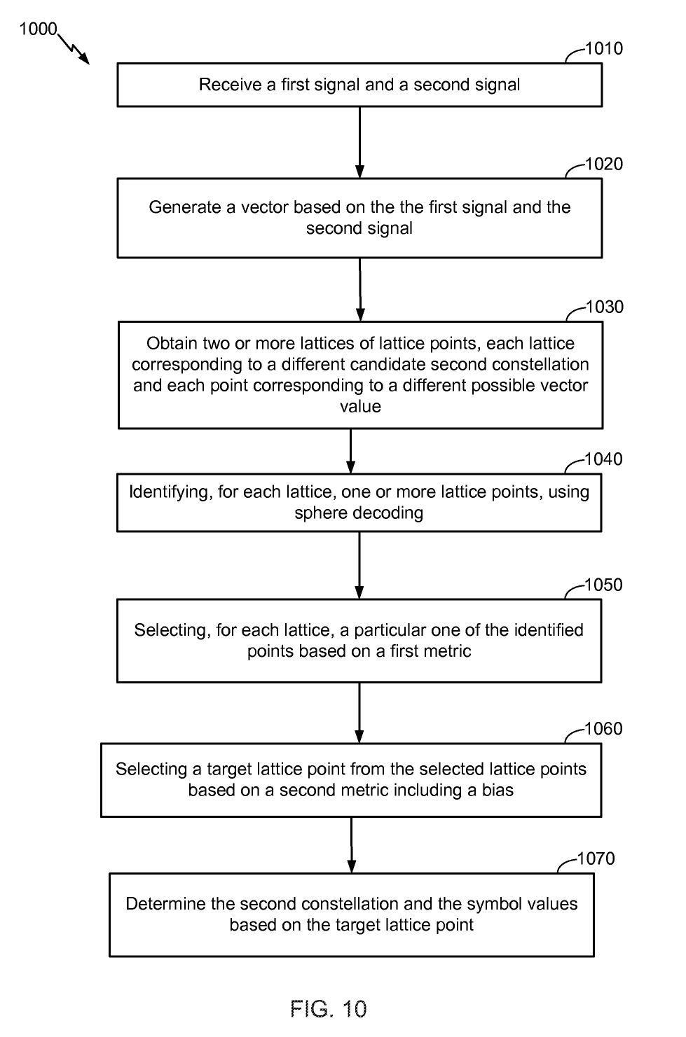

FIG. 10 is a flowchart illustrating a method of determining symbol values. The process 1000 begins, in block 1010, with the reception of a first signal and a second signal. The reception can be performed, for example, by the receiver 422A or 454A in FIG. 4.

In one embodiment, the first signal comprises at least M measurements, wherein M is a positive integer. Each measurement includes at least a first symbol value selected from a first constellation weighted by a first gain and a second symbol value selected from a second constellation weighted by a second gain. The first symbol value and the second symbol value may be added together linearly or non-linearly. That is, the received symbol can be the first symbol value added to the second symbol value with other components also added. Each received symbol may also include a noise component.

In one embodiment, the second signal comprises at least M measurements. Each measurement includes at the same symbols at the first signal weighted differently. Thus, if the first signal comprises g1a1+g2b1 and g1a2+g2b2 and g1a3+g2b3, the second signal comprises g3a1+g4b1 and g3a2+g4b2 and g3a3+g4b3.

In some embodiments, the number of measurements in the first and second signal may be different.

From the received signals, the process continues to block 1020 where a vector is generated based on the first and second signals. The generation may be performed by the processor 430 or 470 of FIG. 4. In one embodiment, the vector is the concatenation of the M measurements of the first signal and the M measurements of the second signal. In one embodiment, the vector is normalized. In another embodiment, the M measurements of the first signal and the M measurements of the second signal are interleaved to generate the vector.

The process continues to block 1030, where lattices are obtained. Although block 1030 is described after block 1020, it is appreciated that the steps described with respect to block 1020 and 1030 could be performed simultaneously, overlapping in time, or in reverse order.

In block 1030, two or more lattices of lattice points are obtained, with each lattice corresponding to a different candidate second constellation. The lattices can be obtained, for example, by the processor 430 or 470 of FIG. 4 possibly in conjunction with the memory 432 or 472. The different candidate second constellations can be, for example, QPSK, 8-QAM/8-PSK, or 16-QAM. In one embodiment, each point in the obtained lattices corresponds to a different possible vector value generated from M possible first symbol values, each selected from the first constellation, and M possible second possible values, each selected from a candidate second constellation. In one embodiment, each point in the obtained lattices correspond to a different possible vector value generated from possible symbol values weighted by appropriate gains.

Once the lattices and vector are generated, the process continues to block 1040 where, for each lattice, one or more points are identified using sphere decoding. The identification can be performed, for example, by the processor 430 or 470 of FIG. 4. In one embodiment, the identified points are those within a predetermined radius of the vector. The distance can be measured using the 1-norm, 2-norm, or infinite-norm distance definition.

In block 1050, for each lattice, a particular one of the identified points is selected based on a first metric. The selection can be performed, for example, by the processor 430 or 470 of FIG. 4. The first metric may be a distance-based metric. In one embodiment, the lattice point which is closest to the vector is selected.

Next, in block 1060, a target lattice point is selected from the selected lattice points based on a second metric including a bias. The selection can be performed, for example, by the processor 430 or 470 of FIG. 4. The second metric may be a distance-based metric. In another embodiment, the second metric may be based on a maximum likelihood. In one embodiment, the bias is based on the number of second symbols, the first constellation, the candidate second constellation, and a noise variance. The noise variance may be measured or estimated.

Finally, in block 1070, the second constellation and the symbol values are determined based on the target lattice point. The determination may be performed, for example, by the processor 430 or 470 of FIG. 4. In one embodiment, the determination does not include determination of the second constellation. In another embodiment, the determination does not include determination of the second symbols, only the first symbols.

In some embodiments, the process 1000 returns block 1010 and repeats.

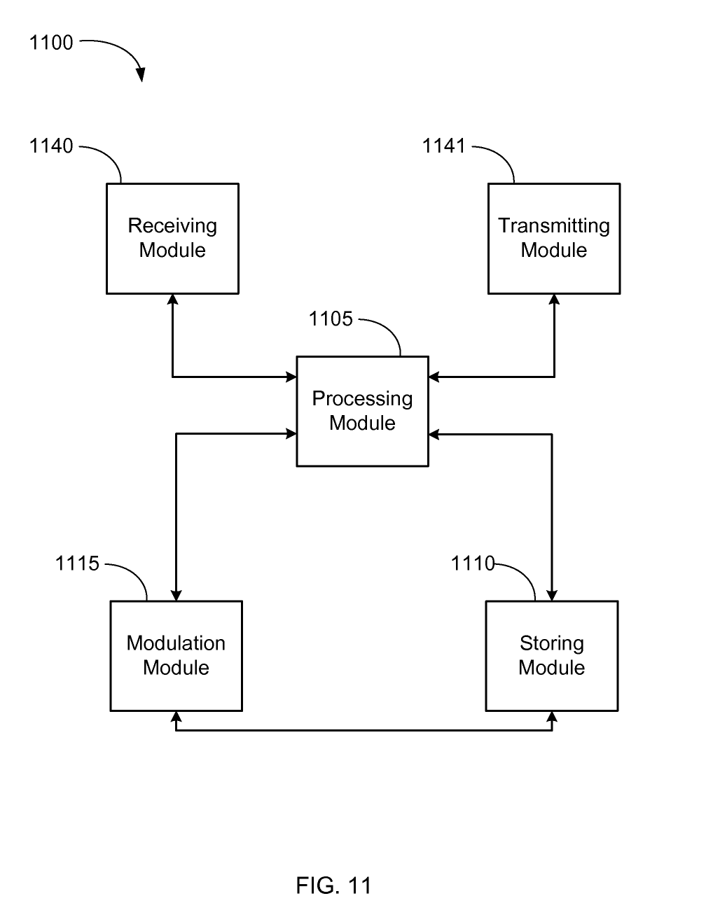

FIG. 11 is a functional block diagram of a wireless communication device 1100 which may be used in one of the communication networks of FIG. 2. The device 1100 may comprise an AT, a mobile phone, a macro node, a femto node, a NodeB, a cell, and/or any other device which may be used to communicate with other devices in the wireless communication system 200 shown in FIG. 2.

The device 1100 may comprise a receiving module 1140 configured to receive an inbound wireless message and/or wireless signals from the other devices (e.g., the macro node 235. The receiving module 1140 may be configured to measure conditions of the wireless link between the device 1100 and the femto node 210. In one embodiment, the receiving module 1140 may measure at least one of a data rate, noise, signal power, and signal to noise ratio of the wireless signals received by the device 1100. In another embodiment, the receiving module 1140 may provide data indicative of the conditions of the wireless link (e.g., noise level, signal power, and/or signal to noise ratio) to a processing module 1105. In one embodiment, the receiving module 1140 may also measure signals received from other devices (e.g., femto node 212 and/or the macro node 235). The transmitting module 1141 may be configured to transmit an outbound wireless message and/or wireless signals to the other devices such as the macro node 235 and/or the AT 221.

A processing module 1105 may be coupled to both the receiving module 1140 and the transmitting module 1141. The processing module 1105 may be configured to process information for storage, transmission, and/or for the control of other components of the device 1100. The processing module 1105 may further be coupled to a storing module 1110. The storing module 1110 may be configured to store information before, during or after processing. The storing module 1110 may store constellations for different modulation schemes. The receiving module 1140 may pass the inbound wireless message to the processing module 1105 for processing. The processing module 1105 may store the inbound wireless message in the storing module 1110. The processing module 1105 may also read information from or write information to the storing module 1110. The processing module 1105 may process the outbound wireless message passing the outbound wireless message to the transmitting module 1141 for transmission. The processing module 1105 may obtain the outbound wireless message from the storing module 1110 and/or may use data obtained from the storing module 1110 to process the outbound wireless message. In one embodiment, the processing module 1105 may obtain data indicative of the conditions of the wireless link from the receiving module 1140. The processing module 1105 may process the data indicative of the conditions of the wireless link. In another embodiment, the processing module 1105 may also store the data indicative of the conditions of the wireless link in the storing module 1110.

The processing module 1105 may also be coupled to a modulation module 1115. The modulation module 1115 may be configured to perform the actions and/or functions described in conjunction with FIGS. 5-10 and 12-13. In one embodiment, the modulation module 1115 may obtain constellations for different modulation schemes from the storing module 1110. In another embodiment, the modulation module 1115 may perform sphere decoding as described in FIG. 8. In one embodiment, the modulation module 1115 may generate search trees based on, at least in part, the wireless signals received by the receiving module 1140 and the modulation scheme stored in the storing module 510. In another embodiment, the modulation module 1115 may prune the search trees as described in FIGS. 9-10. In one embodiment, the modulation module 1115 may store the generated and/or pruned search trees in the storing module 1110. In another embodiment, the modulation module 1115 may operating in conjunction with the processing module 1105 to perform the functionalities described above. For further detail on functions that the modulation module 1115 may perform, see the written description for FIGS. 5-10 and 12-13.

The receiving module 1140 and the transmitting module 1141 may comprise an antenna (not shown in FIG. 5). The receiving module 1140 may be configured to demodulate the inbound wireless messages coming from other wireless communication devices. The transmitting module 1141 may be configured to modulate outbound wireless messages going to the other wireless communication devices. The outbound wireless messages may be transmitted via the antenna and the inbound wireless messages may be received via the antenna. The antenna may be configured to communicate with other wireless communication devices over one or more channels. The outbound and/or inbound wireless messages may comprise voice and/or data-only information (collectively referred to herein as “data”). The processing module 1105 and/or the modulation module 1115 may provide data to be transmitted.

The storing module 1110 may comprise processing module cache, including a multi-level hierarchical cache in which different levels have different capacities and access speeds. The storing module 1110 may also comprise random access memory (RAM), other volatile storage devices, or non-volatile storage devices. The storage may include hard drives, optical discs, such as compact discs (CDs) or digital video discs (DVDs), flash memory, floppy discs, magnetic tape, and Zip drives.

Although described separately, it is to be appreciated that functional blocks described with respect to the device 1100 need not be separate structural elements. For example, the processing module 1105 and the storing module 1110 may be embodied in a single chip. The processing module 1105 may additionally, or in the alternative, contain memory, such as registers. Similarly, one or more of the functional blocks or portions of the functionality of various blocks may be embodied in a single chip. Alternatively, the functionality of a particular block may be implemented on two or more chips.

One or more of the functional blocks and/or one or more combinations of the functional blocks described with respect to the device 1100, such as the processing module 1105 and the modulation module 1115 may be embodied as a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. One or more of the functional blocks and/or one or more combinations of the functional blocks described with respect to the device 1100 may also be implemented as a combination of computing devices, e.g., a combination of a DSP and a microprocessor, a plurality of microprocessors, one or more microprocessors in conjunction with a DSP communication, or any other such configuration.

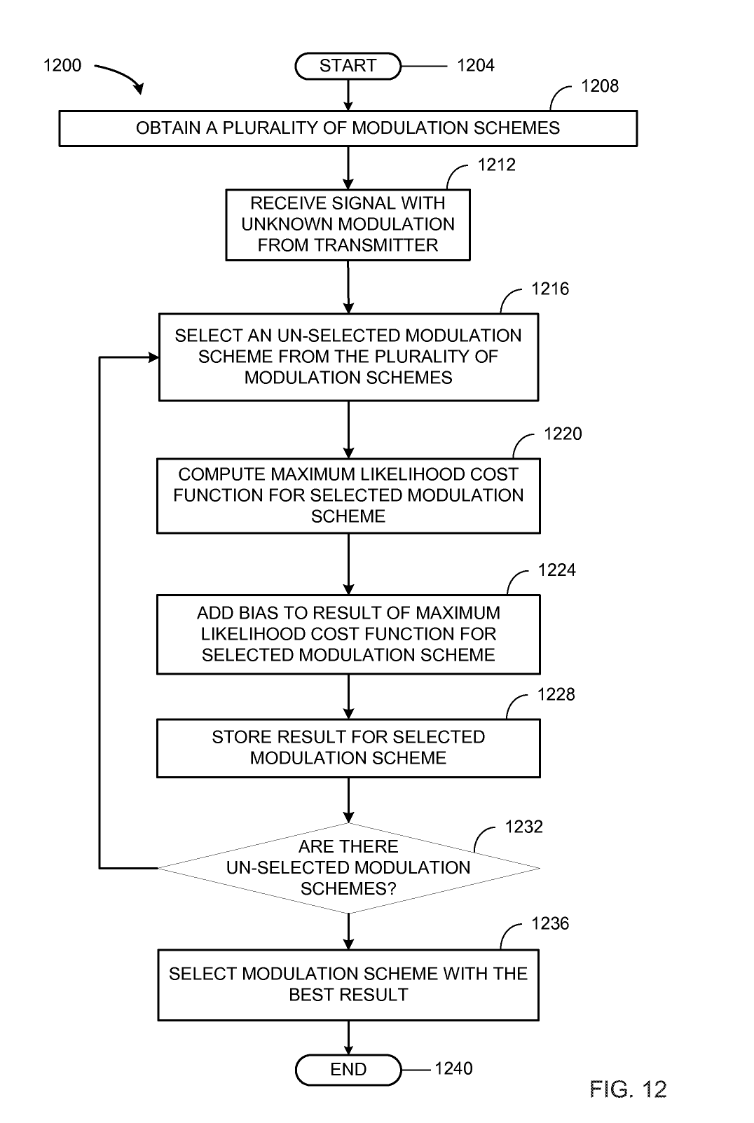

FIG. 12 is a flowchart illustrating a first exemplary process 1200 which maybe performed by the wireless communication devices shown in FIG. 2 (e.g., the AT 221, the macro node 235). The process 1200 begins at start bock 1204 and ends at end block 1240. Reference may be made to elements in FIGS. 2 and 5-11 in the description of FIG. 12. In one embodiment, parts of the process 1200 may be performed by at least one of the processing module 1105 and the modulation module 1115 of the wireless communication device 1100 shown in FIG. 11. In another embodiment, parts of the process 1200 may also use the storing module 1110 and the receiving module 1140 of the device 1100. The process 1200 may be performed each time wireless communication device 1100 receives a signal with an unknown modulation scheme.

The process 1200 starts at start block 1204 and moves to block 1208, where the device 1100 obtains a plurality of modulation schemes which may be used by the wireless communication system 200 shown in FIG. 2. The modulation schemes may be stored in the storing module 1110 of the device 1100. The process 1200 then moves to block 1212 where the device 1100 receives a wireless signal with unknown modulation via the receiving module 1140. After receiving the wireless signal with unknown modulation, the process 1200 then moves to block 1216 where the device 1100 selects modulation scheme from the plurality of modulation schemes. The process 1200 then moves to block 1220 where the device 1100 computes the maximum likelihood cost function for the selected modulation scheme, as discussed above in conjunction with FIGS. 8-10. After computing the maximum likelihood cost function, the process 1200 moves to block 1224, where a bias may be added to the result of the maximum likelihood cost function obtained at block 1220. As discussed above, the bias may be added to the result compensate for noise which may be received by the device 1100 along with the wireless signal. After adding the bias, the process 1200 then moves to block 1228, where the result (with the bias added) is then stored in the storing module 1110.

The process 1200 then moves to block 1232 where the device 1100 may determine if there are any un-selected (e.g. un-tested) modulation schemes. If there are un-selected modulation schemes, the process 1200 moves back to block 1216 where the device 1100 may select the next modulation scheme and compute the maximum likelihood cost function for the next modulation scheme, as discussed above. If there are no un-selected modulation schemes (e.g., no un-tested modulation schemes), the process 1200 then moves to block 1236, where the device 1100 may analyze the results for each of the modulation schemes stored in the storing module 1110 and select the modulation scheme with the best result. As discussed above in FIGS. 8-10, the best result may comprise a probability computing using the maximum likelihood cost function.

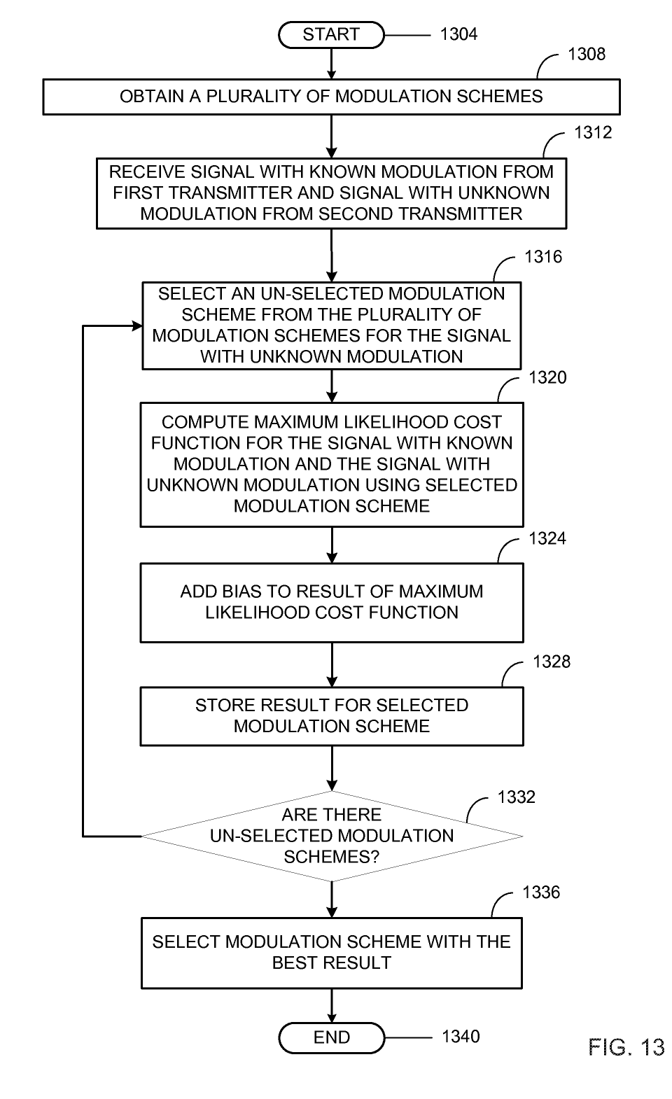

FIG. 13 is a flowchart illustrating a second exemplary process 1300 which maybe performed by the wireless communication devices shown in FIG. 2 (e.g., the AT 221, the macro node 235). The process 1300 begins at start bock 1304 and ends at end block 1340. Reference may be made to elements in FIGS. 2 and 5-11 in the description of FIG. 13. In one embodiment, parts of the process 1300 may be performed by at least one of the processing module 1105 and the modulation module 1115 of the wireless communication device 1100 shown in FIG. 11. In another embodiment, parts of the process 1300 may also use the storing module 1110 and the receiving module 1140 of the device 1100. The process 1300 may be performed each time wireless communication device 1100 receives a signal with an unknown modulation scheme.

The process 1300 starts at start block 1304 and moves to block 1308, where the device 1100 obtains a plurality of modulation schemes which may be used by the wireless communication system 200 shown in FIG. 2. The modulation schemes may be stored in the storing module 1110 of the device 1100. The process 1300 then moves to block 1312 where the device 1100 receives a first wireless signal with known modulation and a second wireless signal with unknown modulation via the receiving module 1140. After receiving the combined wireless signal (e.g., the first signal with known modulation and the second signal with unknown modulation), the process 1300 then moves to block 1316 where the device 1100 selects modulation scheme for the wireless signal with unknown modulation from the plurality of modulation schemes. The process 1300 then moves to block 1320 where the device 1100 computes the maximum likelihood cost function for the selected modulation scheme, as discussed above in conjunction with FIGS. 8-10. After computing the maximum likelihood cost function, the process 1300 moves to block 1324, where a bias may be added to the result of the maximum likelihood cost function obtained at block 1320. As discussed above, the bias may be added to the result compensate for noise which may be received by the device 1100 along with the wireless signal. After adding the bias, the process 1300 then moves to block 1328, where the result (with the bias added) is then stored in the storing module 1110.

The process 1300 then moves to block 1332 where the device 1100 may determine if there are any un-selected (e.g. un-tested) modulation schemes. If there are un-selected modulation schemes, the process 1300 moves back to block 1316 where the device 1100 may select the next modulation scheme and compute the maximum likelihood cost function for the next modulation scheme, as discussed above. If there are no un-selected modulation schemes (e.g., no un-tested modulation schemes), the process 1300 then moves to block 1336, where the device 1100 may analyze the results for each of the modulation schemes stored in the storing module 1110 and select the modulation scheme with the best result. As discussed above in FIGS. 8-10, the best result may comprise a probability computing using the maximum likelihood cost function.

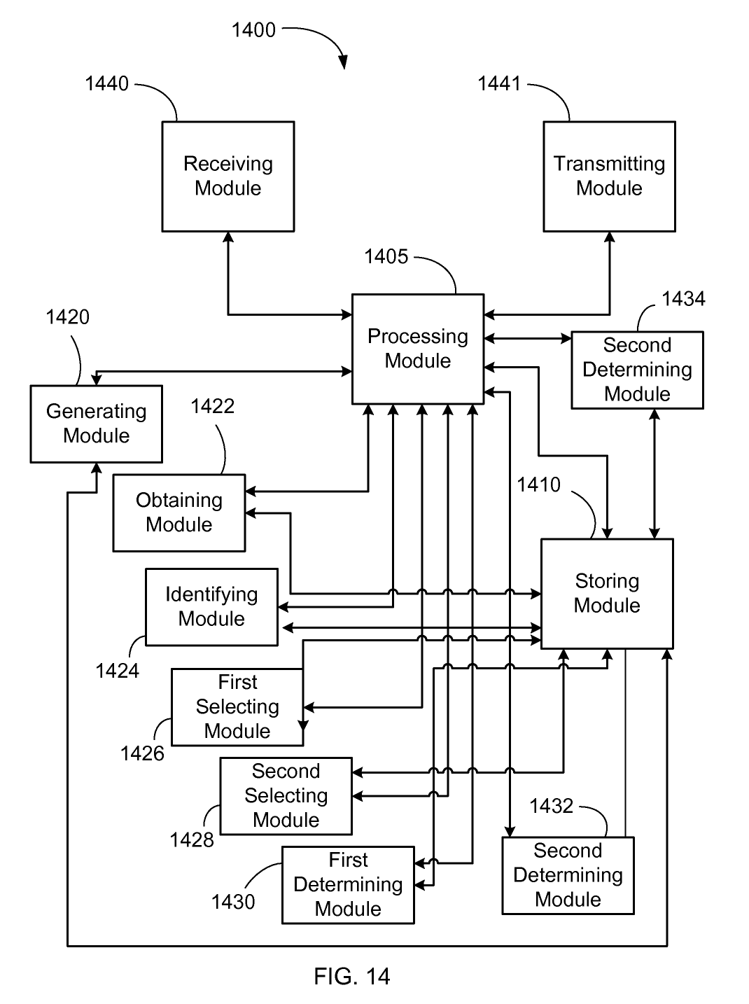

FIG. 14 is a functional block diagram of a second exemplary wireless communication device 1400 in one of the communication networks of FIG. 2 (e.g., the macro node 235 or the AT 221). As shown, the device 1400 may comprise a processing module 1405, a storing module 1410, a receiving module 1430, a transmitting module 1431, a generating module 1420, a obtaining module 1422, an identifying module 1424, a first selecting module 1426, a second selecting module 1428, a first determining module 1430, a second determining module 1432, and a third determining module 1434. The processing module 1405 is coupled to the storing module 1410. The generating module 1420, the obtaining module 1422, the identifying module 1424, the first selecting module 1426, the second selecting module 1428, the first determining module 1430, the second determining module 1432, and the third determining module 1434 are each coupled to the processor 1405. The generating module 1420, the obtaining module 1422, the identifying module 1424, the first selecting module 1426, the second selecting module 1428, the first determining module 1430, the second determining module 1432, and the third determining module 1434 are each coupled to the storing module 1510. The processing module 1505 may correspond at least in some aspects to, for example, a processor as discussed herein. The storing module 1510 may correspond at least in some aspects to, for example, a memory as discussed herein. The receiving module 1530 may correspond at least in some aspects to, for example, a transceiver and/or an antenna as discussed herein. The transmitting module 1531 may correspond at least in some aspects to, for example, a transceiver and/or an antenna as discussed herein. The generating module 1420, the obtaining module 1422, the identifying module 1424, the first selecting module 1426, the second selecting module 1428, the first determining module 1430, the second determining module 1432, and the third determining module 1434 may each correspond at least in some aspects to, for example, the modulation module 1115 shown in FIG. 11, as discussed herein.

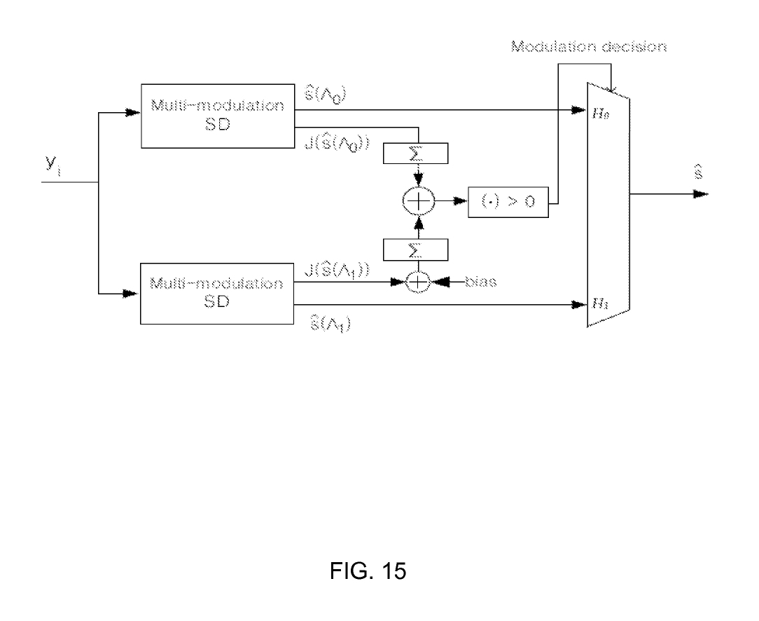

FIG. 15 is a block diagram which illustrates a third exemplary process which may be performed by the wireless communication device shown in FIG. 2. As discussed in FIG. 2, the AT 221 may receive a signal yᵢ. The AT 221 may perform multi-modulation sphere decoding (e.g., performing sphere decoding on a signal comprising multiple signals, each signal using one of a plurality of modulations), as described in FIGS. 8-9. As discussed in FIGS. 8-9, the AT 221 may first perform multi-modulation sphere decoding assuming the macro node 235 and 205 both use QPSK. This is shown by the maximum likelihood cost function J(ŝ( [symbol] ₀)) discussed above. This is also shown in FIG. 15 as the upper multi-modulation SD block. In addition, upper multi-modulation SD block may communicate the closest lattice point ŝ( [symbol] ₀) to the vector v1 shown in FIG. 8, as H₀ to the modulation decision block. The AT 221 may then perform multi-modulation sphere decoding assuming the macro node 235 uses QPSK and the macro node 205 uses 16-QAM. This is shown by the maximum likelihood cost function J(ŝ( [symbol] ₁)) discussed above. This is also shown in FIG. 15 as the lower multi-modulation SD block. In addition, lower multi-modulation SD block may communicate the closest lattice point ŝ( [symbol] ₁) to the vector v1 shown in FIG. 9, as H₁ to the modulation decision block. The maximum likelihood cost functions J(ŝ( [symbol] ₀)) and J(ŝ( [symbol] ₁)) are then compared. If J(ŝ( [symbol] ₀)) is greater than J(ŝ( [symbol] ₁)), then the modulation decision block selects H₀. If J(ŝ( [symbol] ₀)) is less than J(ŝ( [symbol] ₁)), then the modulation decision block selects H₁.

The functionality of the modules of FIGS. 11 and 14 may be implemented in various ways consistent with the teachings herein. In some aspects the functionality of these modules may be implemented as one or more electrical components. In some aspects the functionality of these blocks may be implemented as a processing system including one or more processor components. In some aspects the functionality of these modules may be implemented using, for example, at least a portion of one or more integrated circuits (e.g., an ASIC). As discussed herein, an integrated circuit may include a processor, software, other related components, or some combination thereof. The functionality of these modules also may be implemented in some other manner as taught herein. The functionality described herein (e.g., with regard to one or more of the accompanying figures) may correspond in some aspects to similarly designated “means for” functionality in the appended claims. Referring to FIGS. 11 and 14, the wireless communication device 1100 is represented as a series of interrelated functional modules.

In the above-embodiments, the AT 221 receives a combined signal comprising a first signal using a known modulation (e.g., the wireless signal from the macro node 235) and a second signal using an unknown modulation (e.g., the wireless signal from the macro node 205). In other embodiments, other wireless communication devices may receive a combined signal and may determine the modulation schemes and the symbols transmitted. For example, the macro node 235 may receive a signal with a known modulation scheme from the AT 221 and a signal with an unknown modulation scheme from the AT 222. The macro node 235 may use constellations, search trees, and sphere decoding, as described above, in order to determine what modulation scheme use used by the AT 222 and what symbols are being transmitted by the AT 222. In another example, the femto node 212 may receive a signal with a known modulation scheme from the AT 221 and a signal with an unknown modulation scheme from the AT 222. The femto node 212 may use constellations, search trees, and sphere decoding, as described above, in order to determine what modulation scheme use used by the AT 222 and what symbols are being transmitted by the AT 222.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of: A, B, or C” used in the description or the claims means “A or B or C or any combination of these elements.”

While the specification describes particular examples of the present invention, those of ordinary skill can devise variations of the present invention without departing from the inventive concept. For example, the teachings herein refer to circuit-switched network elements but are equally applicable to packet-switched domain network elements.

Those skilled in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those skilled in the art will further appreciate that the various illustrative logical blocks, modules, circuits, methods and algorithms described in connection with the examples disclosed herein may be implemented as electronic hardware, computer software, or combinations of both. To clearly illustrate this interchangeability of hardware and software, various illustrative components, blocks, modules, circuits, methods and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, a connection may be used to transmit and/or receive computer-readable medium. For example, the software may be transmitted from a website, server, or other remote source using a coaxial cable, fiber optic cable, twisted pair, digital subscriber line (DSL), or wireless technologies such as infrared, radio, and microwave. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed examples is provided to enable any person skilled in the art to make or use the present invention. Various modifications to these examples will be readily apparent to those skilled in the art, and the generic principles defined herein may be applied to other examples without departing from the spirit or scope of the invention. Thus, the present invention is not intended to be limited to the examples shown herein but is to be accorded the widest scope consistent with the principles and novel features disclosed herein.

What is claimed is:

1. A wireless communication apparatus operable in a communication system, the wireless communication apparatus comprising:
a receiver configured to receive a first signal comprising at least M measurements, each measurement comprising at least a first symbol value selected from a first constellation weighted by a first gain and a second symbol value selected from a second constellation weighted by a second gain,
the receiver further configured to receive a second signal comprising at least M measurements, each measurement comprising at least the first symbol value weighted by a third gain and the second symbol value weighted by a fourth gain; and
a circuit configured to:
generate an N-dimensional vector based on the first signal and the second signal, wherein N is at least 2M;
obtain two or more N-dimensional lattices of lattice points, each lattice corresponding to a different candidate second constellation and each lattice point corresponding to a different possible vector value based at least in part on a first M possible symbol values selected from the first constellation and a second M possible symbol values selected from the candidate second constellation;
identify, for each lattice, one or more lattice points, based on the N-dimensional vector, using sphere decoding;
select, for each lattice, a particular one of the identified one or more lattice points based on a first metric;
select a target lattice point from the selected lattice points based on a second metric including a bias based at least in part on M, the first constellation, the candidate second constellation of the selected lattice point, and a noise variance;
determine the second constellation based on the target lattice point; and
determine at least the M first symbol values and the M second symbol values based on the target lattice point.

2. The apparatus of claim 1, wherein the receiver comprises a first antenna configured to receiver the first signal and a second antenna configured to receive the second signal.

3. The apparatus of claim 1, wherein the different second candidate constellations include at least two of QPSK, 8-QAM, and 16-QAM.

4. The apparatus of claim 1, wherein each lattice point corresponds to a different possible vector value based at least in part on the first M possible symbol values weighted with the first gain added to the second M possible symbol values weighted with the second gain and the first M possible symbol values weighted with the third gain added to the second M possible symbol values weighted with the fourth gain.

5. The apparatus of claim 1, wherein the circuit is configured to identify one or more lattice points by determining one or more lattice points within a predetermined distance of the N-dimensional vector.

6. The apparatus of claim 1, wherein the circuit is configured to select a particular one of the identified one or more lattice points based on a distance metric.

7. The apparatus of claim 6, wherein the distance metric is a 2-norm distance metric.

8. The apparatus of claim 6, wherein the circuit is configured to select a particular one of the identified one or more lattice points by selecting the lattice point closest to the N-dimensional vector.

9. The apparatus of claim 1, wherein the second metric is a distance metric.

10. The apparatus of claim 1, wherein the second metric is a maximum likelihood metric.

11. A method of determining a constellation, the method comprising:
receiving a first signal comprising at least M measurements, each measurement comprising at least a first symbol value selected from a first constellation weighted by a first gain and a second symbol value selected from a second constellation weighted by a second gain;
receiving a second signal comprising at least M measurements, each symbol comprising at least the first symbol value weighted by a third gain and the second symbol value weighted by a fourth gain;
generating an N-dimensional vector based on the first signal and the second signal, wherein N is at least 2M;
obtaining two or more N-dimensional lattices of lattice points, each lattice corresponding to a different candidate second constellation and each lattice point corresponding to a different possible vector value based at least in part on a first M possible symbol values selected from the first constellation and a second M possible symbol values selected from the candidate second constellation;
identifying, for each lattice, one or more lattice points, based on the N-dimensional vector, using sphere decoding;
selecting, for each lattice, a particular one of the identified one or more lattice points based on a first metric;
selecting a target lattice point from the selected lattice points based on a second metric including a bias based at least in part on M, the first constellation, the candidate second constellation of the selected lattice point, and a noise variance;
determining the second constellation based on the target lattice point; and
determining at least the M first symbol values and the M second symbol values based on the target lattice point.

12. The method of claim 11, wherein the different second candidate constellations include at least two of QPSK, 8-QAM, and 16-QAM.

13. The method of claim 11, wherein each lattice point corresponds to a different possible vector value based at least in part on the first M possible symbol values weighted with the first weight added to the second M possible symbol values weighted with the second weight and the first M possible symbol values weighted with the third weight added to the second M possible symbol values weighted with the fourth weight.

14. The method of claim 11, wherein identifying one or more lattice points comprises determining one or more lattice points without a predetermined distance of the N-dimensional vector.

15. The method of claim 11, wherein selecting a particular one of the identified one or more lattice points is based on a distance metric.

16. The method of claim 15, wherein the distance metric is a 2-norm distance metric.

17. The method of claim 15, wherein selecting a particular one comprising selecting the lattice point closest to the N-dimensional vector.

18. The method of claim 11, wherein the second metric is a distance metric.

19. The method of claim 11, wherein the second metric is a maximum likelihood metric.

20. A wireless communication apparatus comprising:
means for receiving a first signal comprising at least M measurements, each measurement comprising at least a first symbol value selected from a first constellation weighted by a first gain and a second symbol value selected from a second constellation weighted by a second gain;
means for receiving a second signal comprising at least M measurements, each measurement comprising at least the first symbol value weighted by a third gain and the second symbol value weighted by a fourth gain;
means for generating an N-dimensional vector based on the first signal and the second signal, wherein N is at least 2M;
means for obtaining two or more N-dimensional lattices of lattice points, each lattice corresponding to a different candidate second constellation and each lattice point corresponding to a different possible vector value based at least in part on a first M possible symbol values selected from the first constellation and a second M possible symbol values selected from the candidate second constellation;
means for identifying, for each lattice, one or more lattice points, based on the N-dimensional vector, using sphere decoding;
means for selecting, for each lattice, a particular one of the identified one or more lattice points based on a first metric;
means for selecting a target lattice point from the selected lattice points based on a second metric including a bias based at least in part on M, the first constellation, the candidate second constellation of the selected lattice point, and a noise variance;
means for determining the second constellation based on the target lattice point; and
means for determining at least the M first symbol values and the M second symbol values based on the target lattice point.

21. A computer-readable storage medium having instructions encoded thereon which, when executed by one or more processors, causes an electronic device to perform a method of method of determining a constellation, the method comprising:
receiving a first signal comprising at least M measurements, each measurement comprising at least first symbol value selected from a first constellation weighted by a first gain and a second symbol value selected from a second constellation weighted by a second gain;
receiving a second signal comprising at least M measurements, each symbol comprising at least the first symbol value weighted by a third gain and the second symbol value weighted by a fourth gain;
generating an N-dimensional vector based on the first signal and the second signal, wherein N is at least 2M;
obtaining two or more N-dimensional lattices of lattice points, each lattice corresponding to a different candidate second constellation and each lattice point corresponding to a different possible vector value based at least in part on a first M possible symbol values selected from the first constellation and a second M possible symbol values selected from the candidate second constellation;
identifying, for each lattice, one or more lattice points, based on the N-dimensional vector, using sphere decoding;
selecting, for each lattice, a particular one of the identified one or more lattice points based on a first metric;
selecting a target lattice point from the selected lattice points based on a second metric including a bias based at least in part on M, the first constellation, the candidate second constellation of the selected lattice point, and a noise variance;
determining the second constellation based on the target lattice point; and
determining at least the M first symbol values and the M second symbol values based on the target lattice point.
